(19) United States
(12) Patent Application Publication
(10) Pub. No.: US 2013/0290023 A1
(43) Pub. Date: Oct. 31, 2013

(54) SYSTEM AND METHOD FOR UNDERWRITING INSURANCE POLICIES BASED ON CARDIOVASCULAR RISK

(71) Applicants: H. Thomas Hight, Kennesaw, GA (US); Gregory C. Freeman, Woodstock, GA (US); Gregg R. Secord, East Longmeadow, MA (US)

(72) Inventors: H. Thomas Hight, Kennesaw, GA (US); Gregory C. Freeman, Woodstock, GA (US); Gregg R. Secord, East Longmeadow, MA (US)

(21) Appl. No.: 13/662,108

(22) Filed: Oct. 26, 2012

Related U.S. Application Data
(63) Continuation of application No. PCT/US11/34117, filed on Apr. 27, 2011.
(60) Provisional application No. 61/516,136, filed on Mar. 30, 2011.
(60) Provisional application No. 61/343,623, filed on Apr. 30, 2010.

(51) Int. Cl. G06Q 40/08; G06Q 50/24

(52) U.S. Cl. CPC G06Q 40/08; G06Q 50/24
USPC 705/3

(57) ABSTRACT

The exemplary embodiments of the present invention provide a system and method for providing underwriting insurance policies system on a computer system. The method comprises receiving a request from an applicant for insurance and receiving medical data of the applicant. The method further comprises denying insurance coverage if applicant has high cardiovascular risk, constructing an action plan for reducing the applicant's cardiovascular risk if applicant is denied coverage, and sending the action plan to the applicant. The system includes a tangible storage medium readable by an instruction processing system, means for receiving a request from an applicant for insurance and means for receiving medical data of the applicant. The system further includes means for denying insurance coverage if applicant has high cardiovascular risk, means for constructing an action plan for reducing the applicant's cardiovascular risk if applicant is denied coverage and means for sending the action plan to the applicant.

### CROSS-REFERENCE TO RELATED APPLICATIONS

This application claims the benefit to and is a continuation of International Patent Application Serial No. PCT/US2011/034117, filed Apr. 27, 2011, which claims the benefit of U.S. Provisional patent application entitled “Cardiovascular Risk-Based Method for Underwriting Insurance Policies”, Ser. No. 61/516,136, filed Mar. 30, 2011, and U.S. Provisional Patent Application 61/343,623, filed on Apr. 30, 2010, entitled “Cardiovascular Risk-Based Method for Underwriting Insurance Policies”, all of which are hereby incorporated herein by reference in their entirety for all purposes.

### BACKGROUND OF THE INVENTION

1. Field of the Invention

The present invention generally relates to insurance; and more particularly to a system and method of underwriting insurance policies based on cardiovascular risk.

2. Description of Background

Even though Cardiovascular Disease is the leading cause of death in the United States, individuals with known or future risk of the disease are not properly assessed by insurance companies based on current underwriting methods. The result of the insurance carrier not identifying the degree of cardiovascular risk in insurance applicants is that moderate and high-risk insurance applicants are under-priced, and low-risk applicants are over-priced. This mismatch not only poses a significant disadvantage for the insurance applicants by not being assigned the appropriate premium, but policyholders (for mutual companies) and shareholders (for stock companies) do not maximize value given the inability to effectively manage this risk.

Smaller groups applying for health insurance have posed problems for underwriting, as the risk is difficult to assess, especially compared to larger groups where risk can be spread out over a larger population.

Insurance Agents require timely and competitive underwriting practices with testing that is both highly sensitive and specific (i.e. low false positive and false negative results). The overall objective of these practices is to deliver the lowest price for their applicants' insurance policy. Conversely, insurance carriers are under pressure to operate efficiently, while maintaining target profitability and mortality results consistent with actual-to-expected measures. In the current environment, insurance carriers unknowingly insure large numbers of people who have high risks for cardiovascular events, such as heart attack, stroke and sudden death. The industry currently handles this risk by building it into the pricing structure, which inherently over-prices other healthy applicants, and under-prices higher risk applicants.

However, a need still remains in the art for a simplified system and method to both accurately assess the cardiovascular risk of an applicant, and to implement a treatment plan for moderate and high-risk applicants, offering them the opportunity to reduce their cardiovascular risk and therefore obtain more favorable premiums.

### SUMMARY OF THE INVENTION

Embodiments of the present invention provide a system, method and computer program products for providing underwriting insurance policies system on a computer system.

An exemplary embodiment includes a method for providing underwriting insurance policies system on a computer system. The method comprises receiving a request from an applicant for insurance and receiving medical data of the applicant. The method further comprises denying insurance coverage if applicant has high cardiovascular risk, constructing an action plan for reducing the applicant's cardiovascular risk if applicant is denied coverage, and sending the action plan to the applicant.

Another exemplary embodiment includes a system for providing underwriting insurance policies system on a computer system. Briefly described in terms of architecture, one embodiment of the system, among others, is implemented as follows. The system includes a tangible storage medium readable by the instruction processing system and storing instructions for execution by the instruction processing system, The system further includes means for receiving a request from an applicant for insurance and means for receiving medical data of the applicant. The system further includes means for denying insurance coverage if applicant has high cardiovascular risk, means for constructing an action plan for reducing the applicant's cardiovascular risk if applicant is denied coverage and means for sending the action plan to the applicant.

A further exemplary embodiment includes a computer program product for providing underwriting insurance policies system on a computer system. The computer program product includes a tangible storage medium readable by a computer system and storing instructions or execution by the computer system for performing a method. The method comprises receiving a request from an applicant for insurance and receiving medical data of the applicant. The method further comprises denying insurance coverage if applicant has high cardiovascular risk, constructing an action plan for reducing the applicant's cardiovascular risk if applicant is denied coverage, and sending the action plan to the applicant.

These and other aspects, features and advantages of the invention will be understood with reference to the drawing figure and detailed description herein, and will be realized by means of the various elements and combinations particularly pointed out in the appended claims. It is to be understood that both the foregoing general description and the following brief description of the drawing and detailed description of the invention are exemplary and explanatory of preferred embodiments of the invention, and are not restrictive of the invention, as claimed

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 is a block diagram illustrating an example of the network environment for the underwriting insurance policies system of the present invention.

FIG. 2 is a block diagram illustrating an example of a server utilizing the underwriting insurance policies system of the present invention, as shown in FIG. 1.

FIG. 3 is a flow chart illustrating an example of the operation of the underwriting insurance policies system for the host of the present invention utilized by the server, as shown in FIG. 2.

FIG. 4 is a flow chart illustrating an example of the operation of the applicant configure process on the server that is utilized in the underwriting insurance policies system of the present invention, as shown in FIGS. 2-3.

FIG. 5 is a flow chart illustrating an example of the operation of the applicant analysis process on the server that is utilized in the underwriting insurance policies system of the present invention, as shown in FIGS. 2-3.

FIG. 6 is a flow chart illustrating an example of the operation of the underwriting process on the server that is utilized in the underwriting insurance policies system of the present invention, as shown in FIGS. 2-3.

FIG. 7 is a flow chart illustrating an example of the operation of the treatment process on the server that is utilized in the underwriting insurance policies system of the present invention, as shown in FIGS. 2-3.

The detailed description explains the preferred embodiments of the invention, together with advantages and features, by way of example with reference to the drawings.

### DETAILED DESCRIPTION OF THE INVENTION

The present invention may be understood more readily by reference to the following detailed description of the invention taken in connection with the accompanying drawing figures, which form a part of this disclosure. It is to be understood that this invention is not limited to the specific devices, methods, conditions or parameters described and/or shown herein, and that the terminology used herein is for the purpose of describing particular embodiments by way of example only and is not intended to be limiting of the claimed invention.

The system and method for underwriting insurance policies based on cardiovascular risk invention provides for insurance carriers to accurately assess an applicant's risk, while providing an opportunity for moderate-to-high risk applicants to receive proper medical care, and apply for a more favorable rating at a specified future date.

Technology now exists that identifies people who have higher risks for CV (Cardiovascular) events. Technology also now exists that can dramatically reduce the risk of CV events. This invention makes use of screening technologies to identify risk while allowing for the fact that people can actually reduce their risk (if they are motivated).

The system and method for underwriting insurance policies based on cardiovascular risk invention is designed to effectively lower the cost of all insurance products (i.e. life, health, long-term care, and disability) by incorporating into the application process screening technologies to assess the cardiovascular risk of applicants. The system and method for underwriting insurance policies based on cardiovascular risk invention then assigns the applicant to an appropriate risk category. The system and method for underwriting insurance policies based on cardiovascular risk invention also allows for the possibility that applicants can lower their own risk, and then receive lower premiums as a result of their efforts. The system and method for underwriting insurance policies based on cardiovascular risk invention also provides a more accurate assessment of small group risk, thus increasing access to health insurance by smaller groups who are willing to undergo screening testing for those group applicants in the appropriate age range.

In addition to blood testing done typically for life insurance (e.g., lipid profiles), at least two tests will be used to screen insurance applicants for cardiovascular disease: the CT Coronary Artery Calcium Score (CACS) and the ultrasound examination of peripheral arteries for Intimal Medial Thickness (IMT), the arteries including, but not being limited to, carotid and femoral arteries. Some applicants may be screened by CT alone, some by ultrasound alone, and some with both technologies. Population-based data is available for both technologies, data which allows for the stratification of buyers into high, moderate and low risk groups. Testing for the presence or absence of the actual disease (atherosclerosis) is far more advantageous to the current risk factor analysis and ECG testing which is commonly used by insurance carriers to screen for cardiovascular disease (ECG is not predictive of future risk, and has limited specificity and sensitivity). Far too many applicants are either under-priced with a high risk of future CV event not identified by the ECG study, or are over-priced or denied, due to a false positive findings on the ECG.

There will also be an opportunity to take advantage of other risk markers like waist circumference and waist-hip ratio and blood tests, including genetic tests which may include, but are not limited to the 9p21 test, which relates to the future risk of developing cardiovascular disease. While genetic testing may be precluded within the health insurance industry, there is availability of such testing to assess risk within the life insurance and disability insurance industries. Although genetic testing can help stratify populations as to CV risk, genes can never predict actual future events for an individual. So someone with bad genes may have a normal cholesterol and HDL, normal waist-hip ratio and body-mass-index, and normal blood pressure. So this applicant with bad genes who has developed good habits of eating and exercising well and has no other CV risk factors will be shown to be in the low risk group by CT and/or ultrasound vascular imaging. Therefore this underwriting invention offers the possibility of contextualizing genetic information so that those applicants who are making the right lifestyle choices and the right medication decisions are not penalized. This feature has the effect of preventing the insurance industry from misusing genetic information.

Low risk applicants will receive competitive pricing consistent with long-term mortality risk, and the insurance carrier will effectively attract insurance applicants to this product to encourage favorable risk on its book of business. High risk applicants (i.e. those found to have high risks for cardiovascular events) will not be insurable until certain criteria are met. High risk applicants will be given an opportunity to take corrective measures such as health initiatives and lifestyle changes in order to reduce their cardiovascular risk. Significant savings for the insurance carrier will be realized because this high risk group is denied coverage. Meanwhile, the insurance carrier will have facilitated the proper risk management of this applicant to reduce the future CV event.

Moderate risk applicants will be given an opportunity, like the high risk group, to take corrective measures and unlike the high risk group can receive special underwriting at the time of the initial application. This special underwriting will take the form of a rider on the product being used (i.e. term or permanent coverage for life insurance) and issued with a rating consistent with the mortality cost of these findings. For example, there could be a three-year term rider attached to the product which allows for the rating to be reduced at the end of each year, if the doctor signs off on his patient's compliance with the program. This could be repeated annually until the final year, when the rider would be phased out from the product. This rider is only used only as an example, and could be another type of chassis part of the product design of any reasonable length (preferably 3 to 5 years), which allows for reductions in premium payments with improvement in cardiovascular risk. However, the advantage of a rider is that it allows for this benefit to be incorporated into an insurance carriers entire product portfolio, and not limit an applicant's product preference. The three-year rider product is used only as an example and could be a term of any reasonable length of time such as for example 1-20 years. In the preferred embodiment, the rider is generally in the range of 3-5 years. In the alternative environment, the term policy can range from 1-20 years.

Compared to currently available insurance products (both life insurance and health insurance), this product will generate significant savings for the insurance company and for the low-risk applicants and for the moderate risk applicants.

As for the moderate and high-risk applicants, both groups will be given an opportunity to take corrective measures such as health initiatives and lifestyle changes in order to reduce their cardiovascular risk. The moderate and high-risk applicants will also be referred to medical practitioners who can initiate an effective program of treatment with the hope of dramatic reduction in CV risk. Treatments may include, but are not limited to cessation of smoking, weight reduction, blood pressure therapy, lipid therapy, diabetic or pre-diabetic therapy, treatments that could comprise medications and an effective exercise and/or dietary program. At the end of that risk-reduction program, screening testing can be repeated. Applicants who have achieved their risk reduction goals and test in a lower-risk group can then be offered a policy appropriate to their risk, with lower rates.

In an alternative embodiment, low rates may then be dependent on repeat testing at appropriate intervals in some states.

This invention has applicability to life, health, disability, and long-term care insurance.

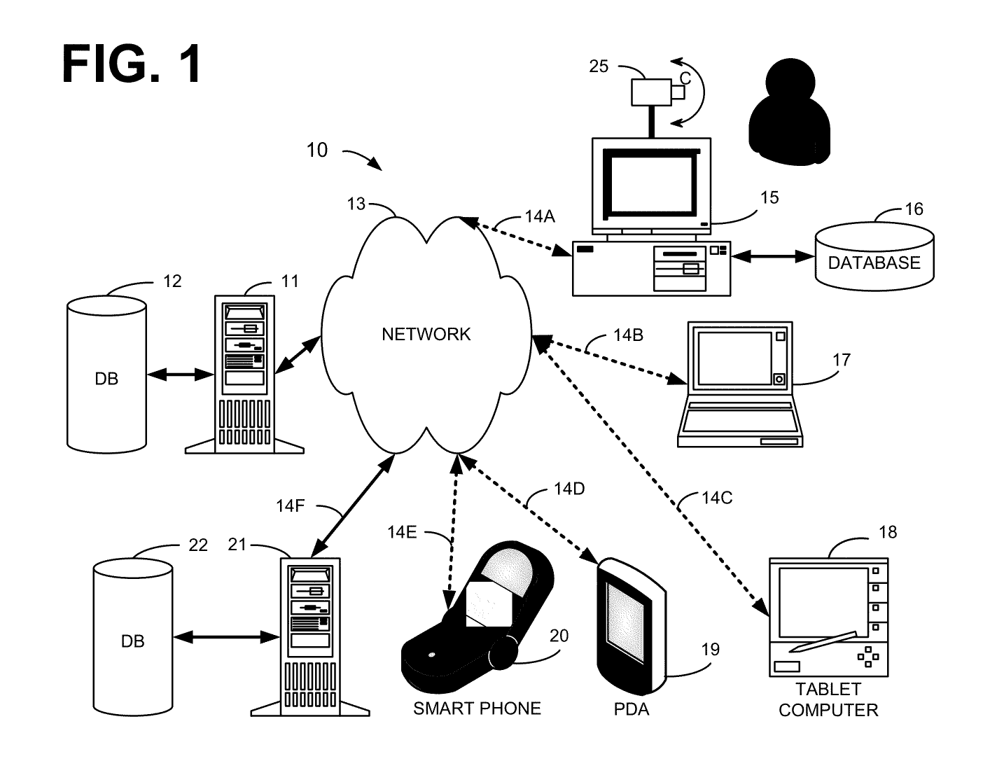

Referring now to the drawings, in which like numerals illustrate like elements throughout the several views. FIG. 1 illustrates an example of the basic components of underwriting insurance policies system 10 using the underwriting insurance policies system used in connection with the preferred embodiment of the present invention. The underwriting insurance policies system 10 includes a server 11 and the remote devices 15, 17-20 that utilize the underwriting insurance system of the present invention.

Each remote device 15 and 17-20 has applications and can have a local database 16. Server 11 contains applications, and a database 12 that can be accessed by remote device 15 and 17-20 via connections 14(A-E), respectively, over network 13. The server 11 runs administrative software for a computer network and controls access to itself and database 12. The remote device 15 and 17-20 may access the database 12 over a network 13, such as but not limited to: the Internet, a local area network (LAN), a wide area network (WAN), via a telephone line using a modem (POTS), Bluetooth, WiFi, cellular, optical, satellite, RF, Ethernet, magnetic induction, coax, RS-485, the like or other like networks. The server 11 may also be connected to the local area network (LAN) within an organization (i.e. a hospital or medical complex).

The remote device 15 and 17-20 may each be located at remote sites. Remote device 15 and 17-20 include but are not limited to, PCs, workstations, laptops, handheld computer, pocket PCs, PDAs, pagers, WAP devices, non-WAP devices, cell phones, palm devices, printing devices and the like. Included with each remote device 15 and 17-20 is an ability to obtain medical information of the applicant. In the remote device 15, there is a medical capturing device 25 for capturing medical data of applicant 26. In remote devices 17-20, they are maybe integrated medical capturing devices for acquiring medical data from the applicant and the ability to upload the medical data of applicant 26 in a digital form to the server 11.

Thus, when a user at one of the remote devices 15 and 17-20 desires to access underwriting insurance policies system status from the database 12 at the server 11, the remote device 15 and 17-20 communicates over the network 13, to access the server 11 and database 12.

Third party computer systems 21 and databases 22 can be accessed by the underwriting insurance system 100 on server 11 in order to access product offerings. Data that is obtained from third party computer system 21 and database 22 can be stored on server 11 and database 12 in order to provide later access to the user on remote devices 15 and 17-20. It is also contemplated that for certain types of data that the remote devices 15 and 17-20 can access the third party computer systems 21 and database 22 (i.e. a doctor's office, hospital or medical complex) directly using the network 13.

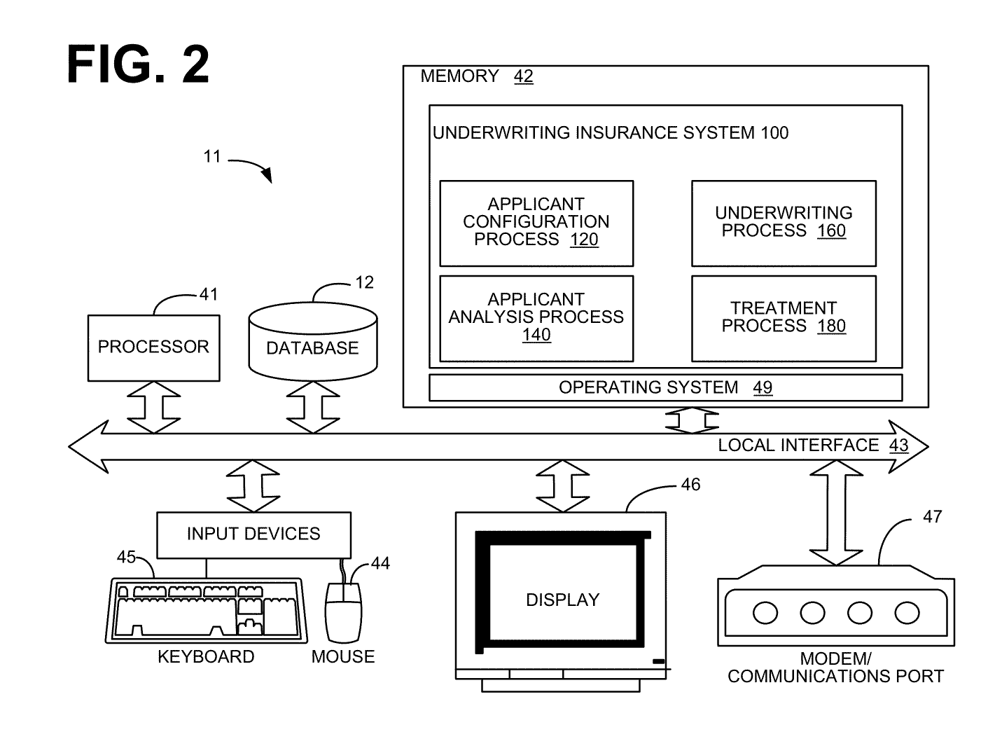

Illustrated in FIG. 2 is a block diagram demonstrating an example of server 11, as shown in FIG. 1, utilizing the underwriting insurance system 100 of the present invention. Server 11 includes, but is not limited to, mainframes, servers, PCs, workstations, laptops, PDAs, palm devices and the like. The processing components of the third party computer systems 21 are similar to that of the description for the server 11 (FIG. 2).

Generally, in terms of hardware architecture, as shown in FIG. 2, the server 11 include a processor 41, memory 42, and one or more input and/or output (I/O) devices (or peripherals) that are communicatively coupled via a local interface 43. The local interface 43 can be, for example but not limited to, one or more buses or other wired or wireless connections, as is known in the art. The local interface 43 may have additional elements, which are omitted for simplicity, such as controllers, buffers (caches), drivers, repeaters, and receivers, to enable communications. Further, the local interface 43 may include address, control, and/or data connections to enable appropriate communications among the aforementioned components.

The processor 41 is a hardware device for executing software that can be stored in memory 42. The processor 41 can be virtually any custom made or commercially available processor, a central processing unit (CPU), data signal processor (DSP) or an auxiliary processor among several processors associated with the server 11, and a semiconductor based microprocessor (in the form of a microchip) or a macroprocessor. Examples of suitable commercially available microprocessors are as follows: an 80x86 or Pentium series microprocessor from Intel Corporation, U.S.A., a PowerPC microprocessor from IBM, U.S.A., a Sparc microprocessor from Sun Microsystems, Inc, a PA-RISC series microprocessor from Hewlett-Packard Company, U.S.A., or a 68xxx series microprocessor from Motorola Corporation, U.S.A.

The memory 42 can include any one or combination of volatile memory elements (e.g., random access memory (RAM, such as dynamic random access memory (DRAM), static random access memory (SRAM), etc.)) and nonvolatile memory elements (e.g., ROM, erasable programmable read only memory (EPROM), electronically erasable programmable read only memory (EEPROM), programmable read only memory (PROM), tape, compact disc read only memory (CD-ROM), disk, diskette, cartridge, cassette or the like, etc.). Moreover, the memory 42 may incorporate electronic, magnetic, optical, and/or other types of storage media. Note that the memory 42 can have a distributed architecture, where various components are situated remote from one another, but can be accessed by the processor 41.

The software in memory 42 may include one or more separate programs, each of which comprises an ordered listing of executable instructions for implementing logical functions. In the example illustrated in FIG. 2, the software in the memory 42 includes a suitable operating system (O/S) 49 and the underwriting insurance system 100 of the present invention. As illustrated, the underwriting insurance system 100 of the present invention comprises numerous functional components including, but not limited to, the applicant configure process 120, applicant analysis process 140, underwriting process 160 and treatment process 180.

A non-exhaustive list of examples of suitable commercially available operating systems 49 is as follows (a) a Windows operating system available from Microsoft Corporation; (b) a Netware operating system available from Novell, Inc.; (c) a Macintosh operating system available from Apple Computer, Inc.; (e) a UNIX operating system, which is available for purchase from many vendors, such as the Hewlett-Packard Company, Sun Microsystems, Inc., and AT&T Corporation; (d) a LINUX operating system, which is freeware that is readily available on the Internet; (e) a run time Vxworks operating system from WindRiver Systems, Inc.; or (f) an appliance-based operating system, such as that implemented in handheld computers or personal data assistants (PDAs) (e.g., Symbian OS available from Symbian, Inc., PalmOS available from Palm Computing, Inc., and Windows CE available from Microsoft Corporation).

The operating system 49 essentially controls the execution of other computer programs, such as the underwriting insurance system 100, and provides scheduling, input-output control, file and data management, memory management, and communication control and related services. However, it is contemplated by the inventors that the underwriting insurance system 100 of the present invention is applicable on all other commercially available operating systems.

The underwriting insurance system 100 may be a source program, executable program (object code), script, or any other entity comprising a set of instructions to be performed. When a source program, then the program is usually translated via a compiler, assembler, interpreter, or the like, which may or may not be included within the memory 42, so as to operate properly in connection with the O/S 49. Furthermore, the underwriting insurance system 100 can be written as (a) an object oriented programming language, which has classes of data and methods, or (b) a procedure programming language, which has routines, subroutines, and/or functions, for example but not limited to, C, C++, C#, Pascal, BASIC, API calls, HTML, XHTML, XML, ASP scripts, FORTRAN, COBOL, Perl, Java, ADA, .NET, and the like.

The I/O devices may include input devices, for example but not limited to, a mouse 44, keyboard 45, scanner (not shown), microphone (not shown), etc. Furthermore, the I/O devices may also include output devices, for example but not limited to, a printer (not shown), display 46, etc. Finally, the I/O devices may further include devices that communicate both inputs and outputs, for instance but not limited to, a NIC or modulator/demodulator 47 (for accessing remote devices, other files, devices, systems, or a network), a radio frequency (RF) or other transceiver (not shown), a telephonic interface (not shown), a bridge (not shown), a router (not shown), etc.

If the server 11 is a PC, workstation, intelligent device or the like, the software in the memory 42 may further include a basic input output system (BIOS) (omitted for simplicity). The BIOS is a set of essential software routines that initialize and test hardware at startup, start the O/S 49, and support the transfer of data among the hardware devices. The BIOS is stored in some type of read-only-memory, such as ROM, PROM, EPROM, EEPROM or the like, so that the BIOS can be executed when the server 11 is activated.

When the server 11 is in operation, the processor 41 is configured to execute software stored within the memory 42, to communicate data to and from the memory 42, and generally to control operations of the server 11 are pursuant to the software. The underwriting insurance system 100 and the O/S 49 are read, in whole or in part, by the processor 41, perhaps buffered within the processor 41, and then executed.

When the underwriting insurance system 100 is implemented in software, as is shown in FIG. 2, it should be noted that the underwriting insurance system 100 can be embodied in any computer-readable medium for use by or in connection with an instruction execution system, apparatus, or device, such as a computer-based system, processor-containing system, or other system that can fetch the instructions from the instruction execution system, apparatus, or device and execute the instructions.

In the context of this document, a “computer-readable medium” can be any means that can store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, propagation medium, or other physical device or means that can contain or store a computer program for use by or in connection with a computer related system or method.

More specific examples (a nonexhaustive list) of the computer-readable medium would include the following: an electrical connection (electronic) having one or more wires, a portable computer diskette (magnetic or optical), a random access memory (RAM) (electronic), a read-only memory (ROM) (electronic), an erasable programmable read-only memory (EPROM, EEPROM, or Flash memory) (electronic), an optical fiber (optical), and a portable compact disc memory (CDROM, CD RAN) (optical). Note that the computer-readable medium could even be paper or another suitable medium, upon which the program is printed or punched (as in paper tape, punched cards, etc.), as the program can be electronically captured, via for instance optical scanning of the paper or other medium, then compiled, interpreted or otherwise processed in a suitable manner if necessary, and then stored in a computer memory.

In an alternative embodiment, where the underwriting insurance system 100 is implemented in hardware, the underwriting insurance system 100 can be implemented with any one or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

The remote devices 15 and 17-20 provides access to the underwriting insurance system 100 of the present invention on server 11 and database 12 using for example, but not limited to an Internet browser. The information accessed in server 11 and database 12 can be provided in the number of different forms including but not limited to ASCII data, WEB page data (i.e. HTML), XML or other type of formatted data. As illustrated, the remote device 15 and 17-20 are similar to the description of the components for server 11 described with regard to FIG. 2. Hereinafter, the remote devices 15 and 17-20 will be referred to as remote devices 15 for the sake of brevity.

In an alternative embodiment, included with remote devices 15 is an ability to obtain medical information of the applicant. In the remote device 15, there may be a medical capturing device 25 for capturing medical data of applicant 26 and the ability to upload the medical data of applicant 26 in a digital form to the server 11. This remote device can be, for example but not limited to, a vascular ultrasound machine, a fingerprint capturing device, a lipid profiles acquiring device (i.e. cholesterol, triglyceride, LDL, HDL), a blood sugar level measuring device, cardio-CRP measuring device or other blood tests measuring device, blood pressure measuring device, weight measuring device, and the like. This would allow for remote diagnostic and evaluation of treatment progress for applicant 26.

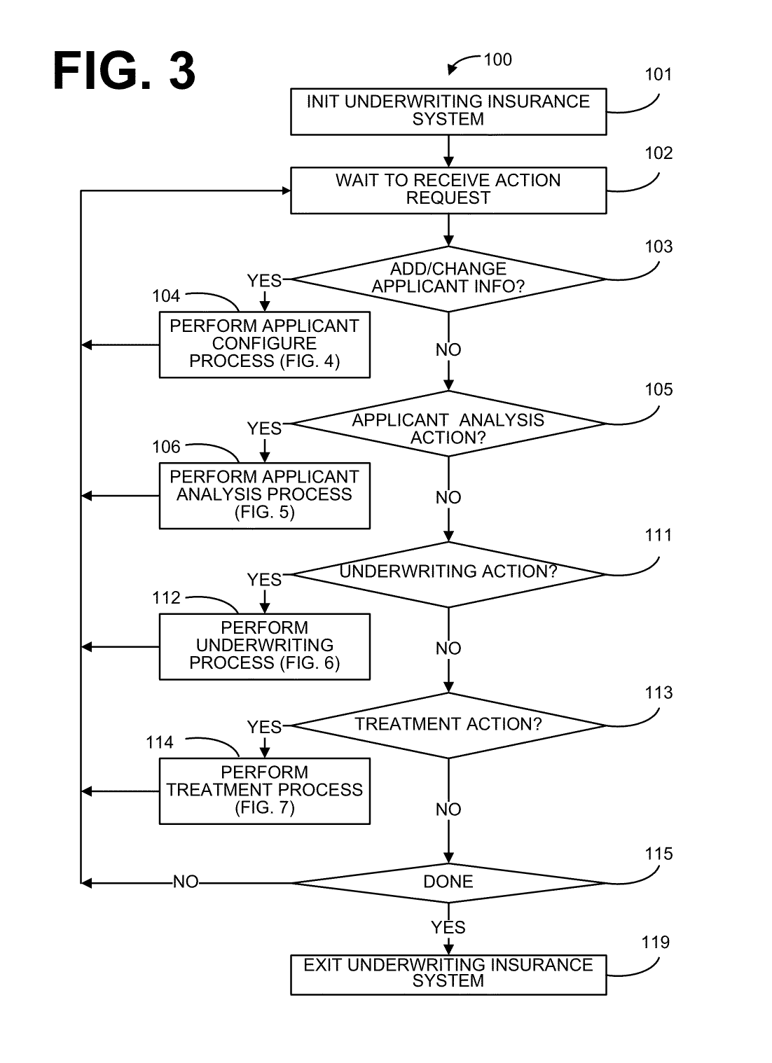

FIG. 3 is a flow chart illustrating an example of the operation of the underwriting insurance system 100 of the present invention utilized by the server 11, as shown in FIG. 2. The underwriting insurance system 100 of the present invention provides for insurance carriers to accurately assess an applicant's risk, while providing an opportunity for moderate-to-high risk applicants to receive proper medical care, and apply for a more favorable rating at a specified future date.

First at step 101, the underwriting insurance system 100 is initialized. This initialization includes the startup routines and processes embedded in the BIOS of the server 11. The initialization also includes the establishment of data values for particular data structures utilized in the underwriting insurance system 100.

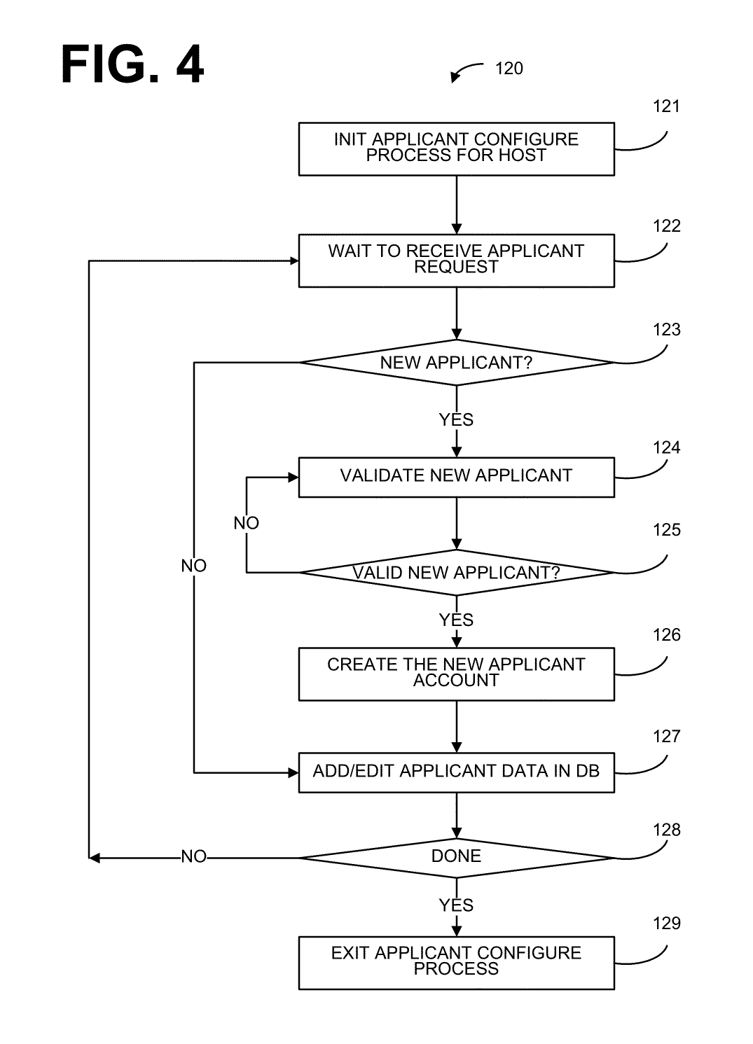

At step 102, the underwriting insurance system 100 waits to receive an action request. Once an action is received at step 102, it is determined if the action is to add a new applicant to the service at step 103. If it is determined that the action is not to add a new applicant to the service, then the underwriting insurance system 100 skip step 105. However, if it is determined in step 103 that a new applicant is to be added, then the underwriting insurance system 100 performs the applicant configure process at step 104. The applicant configure process is herein defined in further detail with regard to FIG. 4. After performing the applicant configure process, the underwriting insurance system 100 returns to step 102.

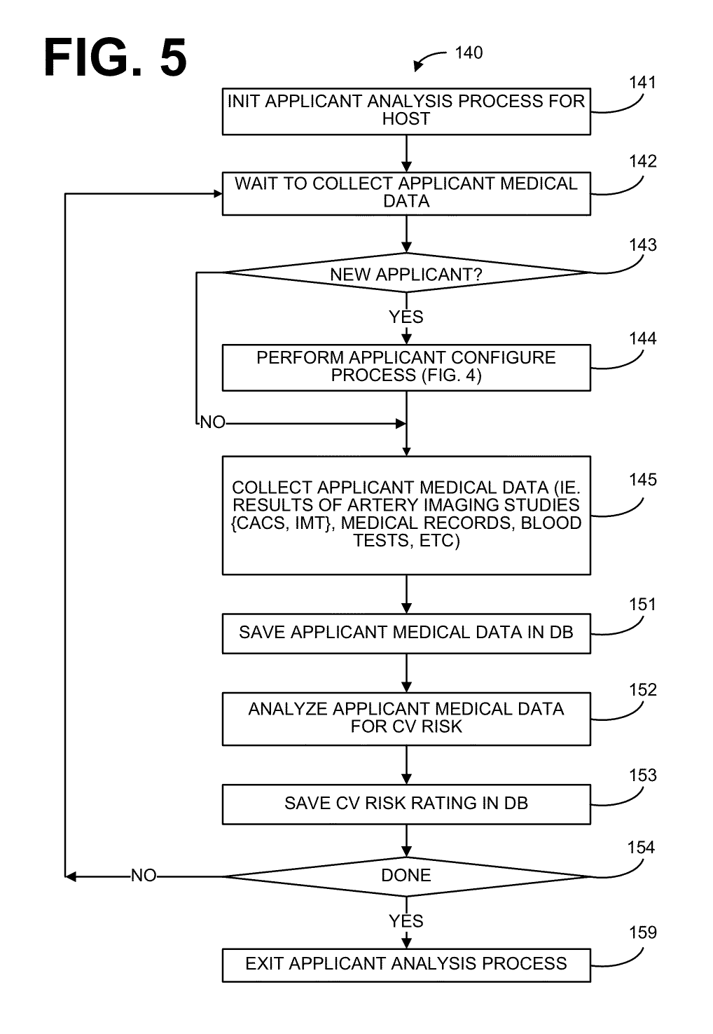

At step 105, it is determined if the action is an applicant analysis action. If it is determined that the action is not an applicant analysis action, then the underwriting insurance system 100 skip step 111. However, if it is determined in step 105 that it is an applicant analysis action, then the underwriting insurance system 100 performs the applicant analysis process at step 106. The applicant analysis process is herein defined in further detail with regard to FIG. 5. After performing the applicant analysis process, the underwriting insurance system 100 returns to step 102.

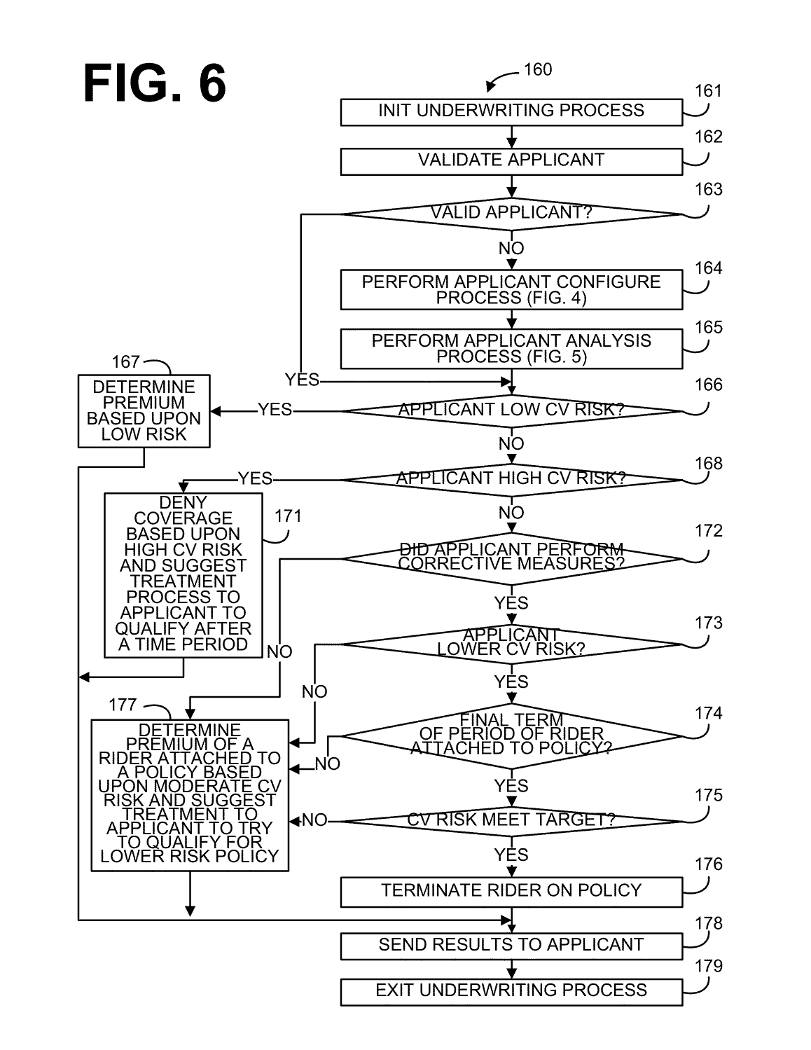

At step 111, it is determined if the action is an underwriting action, i.e. a insurance underwriting evaluation and premium determination. If it is determined that the action is not an underwriting action, then the underwriting insurance system 100 skip step 113. However, if it is determined at step 111 that it is a underwriting action, then the underwriting insurance system 100 performs the underwriting process at step 112. The underwriting process is herein defined in further detail with regard to FIG. 6. After performing the underwriting process, the underwriting insurance system 100 returns to step 102.

At step 113, it is determined if the action is a treatment action. A treatment action is a situation where the medical data of applicant 26 is analyzed and a treatment plan is provided to applicant 26. In the preferred embodiment, the treatment process 180 determines if it is in the best interest of the applicant to see doctor in person. If it is determined that the action is not a treatment action, then the underwriting insurance system 100 skip this step 115. However, if it is determined at step 113 that a treatment action is to be performed, then the underwriting insurance system 100 performs the treatment action at step 114. After performing the treatment action, the underwriting insurance system 100 returns to step 102.

At step 115, it is determined if the underwriting insurance system 100 is to wait for additional action request. If it is determined at step 115 that the underwriting insurance policies system is to wait to receive additional actions, then the underwriting insurance system 100 returns to repeat steps 102 through 115. However, if it is determined at step 115 that there are no more actions to be received, then the underwriting insurance system 100 then exits at step 119.

FIG. 4 is a flow chart illustrating an example of the operation of the applicant configure process 120 on the server that is utilized in the underwriting insurance system 100 of the present invention, as shown in FIGS. 2-3. The applicant configure process 120 establish or modify applicant specific information residing on database 12 (FIG. 2). Once the new applicant information is placed in server 11, it is available for applicant analysis and product ordering. A brief overview of one exemplary process is as follows: 1) waits to receive an applicant configure request; 2) determine if the applicant is a new applicant; 3) Validate and store new applicant name; 4) upload new/modify existing applicant information from local machine; and 5) done.

First at step 121, the applicant configure process 120 is initialized. This initialization includes the startup routines and processes embedded in the BIOS of the server 11. The initialization also includes the establishment of data values for particular data structures utilized in the applicant configure process 120.

At step 122, the applicant configure process 120 waits to receive a new applicant request. Once a new applicant request has been received, the applicant configure process 120 determines if the applicant is a new applicant to the underwriting insurance system 100. If it is determined at step 123 that the applicant is not a new applicant, then the applicant configure process 120 skip step 127 to enable the applicant to enter new or edit existing applicant data. However, if it is determined at step 123 that the applicant is a new applicant, then the applicant configure process 120 validates the new applicant at step 124. The new applicant is registered at this time and is validated against information in database 12 at step 125. If the new applicant is not valid, then the applicant configure process 120 returns to step 124. However, if the new applicant is valid, then the applicant configure process 120 enables the new applicant to create a new applicant account at step 126.

At step 127, the applicant configure process 120 enables the applicant to add or edit existing applicant data in the new applicant account.

At step 128, it is determined if the applicant configure process 120 is to wait for additional applicant requests. If it is determined at step 128 that the applicant configure process 120 is to wait for additional applicant requests, then the applicant configure process 120 returns to repeat steps 122 through 128. However, if it is determined at step 128 that there are no more applicant actions to be received, then the applicant configure process 120 then exits at step 129.

FIG. 5 is a flow chart illustrating an example of the operation of the applicant analysis process 140 on the server that is utilized in the underwriting insurance system 100 of the present invention, as shown in FIGS. 2-3. Once the new applicant is placed in server 11, it is available for accumulative applicant's medical data and analyzing applicants medical data for cardiovascular risk. A brief overview of one exemplary process is as follows: 1) is applicant account established; 2) acquire applicant's medical data and save to a database 12; 3) analyze applicants medical data; 4) determine the applicant's cardiovascular risk; 5) save to applicant's cardiovascular risk rating in a database 12; and 6) done.

First at step 141, the applicant analysis process 140 is initialized. This initialization includes the startup routines and processes embedded in the BIOS of the server 11. The initialization also includes the establishment of data values for particular data structures utilized in the applicant analysis process 140.

At step 142, the applicant analysis process 140 waits to receive an applicant transaction. Once an applicant transaction has been received, the applicant analysis process 140 then verifies that the applicant account exists at step 143. If the applicant account exists, then the applicant analysis process 140 skip step 145. However, if an applicant account does not exist for the new applicant, then the applicant configure process 120 is performed at step 144.

At step 145, the applicant's medical data is acquired. Examples of this medical data include, but are not limited to, lipid profiles (i.e. total cholesterol, triglyceride, LDL, HDL), blood sugar level, cardio-CRP, (or other blood tests), blood pressure, weight, waist-hip ratio, body-mass-index, family history, medical records, genetic data, and arterial imaging results from technologies such as the CT Coronary Artery Calcium Score (CACS) and the ultrasound measurement of periphoral artery Intimal Medial Thickness (IMT). Population-based data is available for both CT Coronary Calcium score and ultrasound IMT measurement technologies, which allows for the stratification of insurance applicants into high, moderate and low risk groups. Testing for the presence of arterial disease is far more advantageous compared to the current practice of evaluating risk factors and ECG testing, which has limited specificity and sensitivity. Far too many applicants are either under-priced with a high risk of future CV event not identified by the ECG study, or are over-priced or denied, due to a false positive findings on the ECG.

There will also be an opportunity to take advantage of other risk markers like waist circumference and waist-hip ratio and blood tests, including genetic tests which may include, but are not limited to the 9p21 test, which relates to the future risk of developing cardiovascular disease. While such testing may be precluded within the health insurance industry, there is availability of such testing to assess risk within the life insurance and disability insurance industries.

At step 151, the applicant's 26 medical data is saved in a database. If this is not applicant's 26 first analysis process, the applicant analysis process 140 accumulative the applicant's medical data with previously acquired applicant medical data.

At step 152, the applicant's medical data for cardiovascular risk is analyzed, based on comparison of the applicant's arterial imaging test results (CACS+/−IMT) to the age-and-gender-matched cohort from population studies. Applicants are assigned to high, medium and low-risk groups based on the applicant's percentile score relative to their age-and-gender-matched cohort. This process may also be modified by mathematical risk assessment models such as the Framingham calculator, and by other data such as blood test results or the applicant's medical record.

At step 153, the applicant analysis process 140 6P cardiovascular risk rating for the applicant 26 in database 12 with the action plan and treatment protocols. The applicant analysis process 140 also forwards the action plan and treatment protocol to the applicant in the predetermined communication form. The predetermined communication form could be an e-mail, text message (i.e. SMS), snail mail, or by a phone call.

At step 154, it is determined if the applicant analysis process 140 is to wait for additional applicant transactions. If it is determined at step 154 that the applicant analysis process 140 is to wait for additional applicant transactions, then the applicant analysis process 140 returns to repeat steps 142 through 154. However, if it is determined at step 154 that there are no more applicant transactions to be received, then the applicant analysis process 140 then exits at step 159.

FIG. 6 is a flow chart illustrating an example of the operation of the underwriting process 160 utilized in the underwriting insurance system 100 of the present invention, as shown in FIGS. 2-3. Using state of the art screening technology in the underwriting process will save money for the insurance company and for low-risk applicants. Referring moderate and high-risk patients to effective treatment programs that actually reduce CV risk will make those savings more widely accessible. Noteworthy is the assignment of applicants to one of numerous risk categories, although only three (low, moderate and high) are mentioned here for illustration. There may be 5 or more risk categories.

First at step 161, the underwriting process 160 is initialized. This initialization includes the startup routines and processes embedded in the BIOS of the server 11. The initialization also includes the establishment of data values for particular data structures utilized in the underwriting process 160.

At step 162, the underwriting process 160 waits to receive an applicant transaction. Once an applicant transaction has been received, the underwriting process 160 then validates the applicant at step 163. The applicant is validated against information in database 12. If the applicant is valid, the underwriting process 160 skip's to step 166. However, if the applicant is not valid, then the underwriting process 160 performs the applicant configure process at step 164 defined with regard to FIG. 4 and the applicant analysis process at step 165 defined with regard to FIG. 5.

At step 166, the underwriting process 160 then determines if the applicant has a low cardiovascular risk. In one embodiment, this low cardiovascular risk is determined as being in the lowest 25% of risk in the population. In another embodiment, low cardiovascular risk is determined by being in the lowest 40% of the population, based on the process described above (paragraph 0072). In another embodiment, low cardiovascular risk is determined by being in the lowest 50% of the population. If it is determined at step 166 that the applicant does not qualify as a low cardiovascular risk, then the underwriting process 160 moves to step 168. However, if it is determined that the applicant's cardiovascular rating is qualified as a low risk, then the underwriting process 160 determines the applicant's premium based upon the low risk rating at step 167 and then skips to step 178. In one embodiment, the premium of the low risk policy is discounted primarily based upon how low the cardiovascular risk is. Other factors in the determination of the premium include, but are not limited to, prior claim history, family history and data from the medical record and may also include data collected and analyzed in steps 145 and 152.

At step 168, it is determined if the applicant has a high cardiovascular risk. In one embodiment, this high cardiovascular risk is determined as being in the highest 25% of risk in the population. In another embodiment, high risk may be defined by a different segment, such as the top 15%, or the top 40%, for example. If it is determined at step 168 that the applicant does not qualify as a high cardiovascular risk, then the underwriting process 160 skips to step 172. However, if it is determined at step 168 that the applicant's cardiovascular rating is qualified as a high risk, then the underwriting process 160 denies insurance coverage based upon the high cardiovascular risk at step 171. The underwriting process 160 also prepares a suggestion to the applicant to undertake treatment in order to attempt to qualify for coverage after a predetermined period of time of performing the treatment. The underwriting process 160 then skips to step 178.

At step 172, it is determined whether the applicant has performed corrective measures (i.e. performed treatment for a predetermined period of time). If it is determined at step 172 that the applicant has not performed corrective treatment for a predetermined amount of time, then the underwriting process 160 skips the step 177 to determine the premium based upon a moderate cardiovascular risk. In one embodiment the policy is a time-limited rider to the policy. However, if it is determined that the applicant has performed the corrective measures for a predetermined amount of time, and that repeat arterial imaging test results have improved, reflecting a lower anticipated cardiovascular risk, then the applicant has lowered their cardiovascular risk at step 173. If it is determined that the applicant has not lowered their cardiovascular risk, then the underwriting process 160 skips the step 177 to determine the premium based upon a moderate cardiovascular risk.

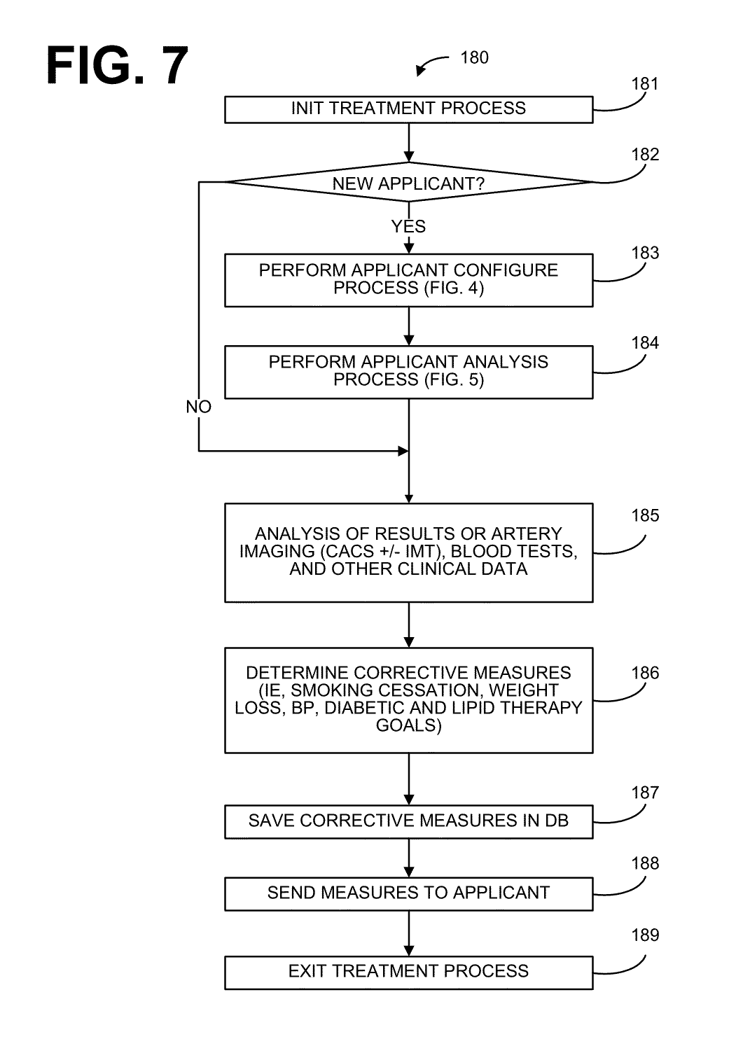

However, if it is determined at step 173, that the applicant has lowered their cardiovascular risk, then it is determined if the rider is in its final term at step 174. If it is determined that the rider is not in its final term, then the underwriting process 160 skips the step 177 to determine the premium based upon a moderate cardiovascular risk. However, if it is determined at step 174 that the rider is in its final term, then it is determined at step 175 if the cardiovascular risk of the applicant meets the target risk rating identified in the treatment process here in defined in further detail with regard FIG. 7. If it is determined that the applicant has met the target risk rating, then the underwriting process 160 terminates the rider and continues the premium based on the underlying product (i.e. term or permanent insurance) at step 176. In one embodiment, the premium of the permanent policy is based primarily on the cardiovascular risk. However, participation in a treatment process and success in lowering the cardiovascular risk will factor in as discounts to the base premium. In another embodiment, the discount to the base premium in subsequent years is based upon applicants maintaining a comparable cardiovascular risk and maintenance of health initiatives/lifestyle changes. The underwriting process 160 then skips the step 178.

At step 177, the underwriting process 160 determines the premium of a policy with the rider attached based upon the cardiovascular risk of the applicant. In one embodiment, the premium of the policy with the rider is based primarily on the cardiovascular risk. However, participation in a treatment process and success in lowering the cardiovascular risk will factor in as discounts to the base premium.

At step 178, the underwriting process 160 sends the underwriting results to the applicant and then exits at step 179.

FIG. 7 is a flow chart illustrating an example of the operation of the treatment process 180 on the server that is utilized in the underwriting insurance system 100 of the present invention, as shown in FIGS. 2-3. The treatment process 180 generates an action plan and treatment protocol in order to lower the cardiovascular risk of the applicant. The action plan and treatment protocol may be targeted specifically for the current applicant, or may be a generalized planned for each type of cardiovascular risk and the particulars of the applicant.

First at step 181, the treatment process 180 is initialized. This initialization includes the startup routines and processes embedded in the BIOS of the server 11. The initialization also includes the establishment of data values for particular data structures utilized in the treatment process 180.

At step 182, the treatment process 180 determines if the applicant performing the treatment action is a new applicant. If it is determined at step 182 that the action request is not from a new applicant, then the treatment process 180 skips this step 185. However, if it is determined at step 182 that the action request is from a new applicant, then the treatment process 180 performs the applicant configure process at step 183 defined with regard to FIG. 4 and the applicant analysis process at step 184 defined with regard to FIG. 5.

At step 185, the applicant's medical data is analyzed, based on comparison of the applicant's arterial imaging test results (CACS+/−IMT) to the age-and-gender-matched cohort from population studies. Applicants are re-assessed and re-assigned to high, medium and low-risk groups based on the applicant's percentile score relative to their age-and-gender-matched cohort. This process may also be modified by mathematical risk assessment models such as the Framingham calculator, and by compliance with lifestyle changes such as weight loss and smoking cessation, and by blood test results such as cholesterol or HDL.

At step 186, the treatment process 180 determines that corrective measures are necessary in order to lower the cardiovascular risk of the applicant. These corrective measures may include, but are not limited to, diet, weight loss, smoking cessation, blood pressure therapy, lipid therapy, diabetic therapy and the like. These corrective measures are then incorporated into an action plan.

At step 187, the treatment process 180 saves the action plan and treatment protocol in database 12. At step 188, the treatment process sends the action plan and treatment protocol to applicant 26, to be implemented by the applicant and his or her personal medical provider. The treatment process 180 then exits at step 189.

Any process descriptions or blocks in flow charts should be understood as representing modules, segments, or portions of code which include one or more executable instructions for implementing specific logical functions or steps in the process, and alternate implementations are included within the scope of the preferred embodiment of the present invention in which functions may be executed out of order from that shown or discussed, including substantially concurrently or in reverse order, depending on the functionality involved, as would be understood by those reasonably skilled in the art of the present invention.

It should be emphasized that the above-described embodiments of the present invention, particularly, any “preferred” embodiments, are merely possible examples of implementations, merely set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and the present invention and protected by the following claims.

1. A method for delivering underwriting insurance policies embodied in a computer program product for execution on an instruction processing system, comprising a tangible storage medium readable by the instruction processing system and storing instructions for execution by the instruction processing system for performing the method comprising:
receiving a request from an applicant for insurance;
receiving medical data of the applicant;
denying insurance coverage if applicant has high cardiovascular risk;
constructing an action plan for reducing the applicant's cardiovascular risk if applicant is denied coverage; and
sending the action plan to the applicant.

2. The method of claim 1, wherein the receiving medical data further comprises receiving coronary artery information.

3. The method of claim 2, wherein the receiving medical data further comprises receiving carotid artery information.

4. The method of claim 2, wherein the receiving medical data further comprises receiving femoral artery information.

5. The method of claim 1, further comprising:
determining if a referral to a local doctor is necessary to construct the action plan.

6. The method of claim 1, further comprising:
determine cost of the insurance coverage if applicant has moderate cardiovascular risk;
constructing an action plan for reducing the applicant's cardiovascular risk if applicant is determined to have moderate cardiovascular risk; and
sending the action plan to the applicant.

7. A system that provides underwriting insurance policies system on an instruction processing system, comprising:
a tangible storage medium readable by the instruction processing system and storing instructions for execution by the instruction processing system;
means for receiving a request from an applicant for insurance;
means for receiving medical data of the applicant;
means for denying insurance coverage if applicant has high cardiovascular risk;
means for constructing an action plan for reducing the applicant's cardiovascular risk if applicant is denied coverage; and
means for sending the action plan to the applicant.

8. The system of claim 7, wherein the means receiving medical data further comprises means for receiving coronary artery information.

9. The system of claim 8, wherein the means receiving medical data further comprises means for receiving carotid artery information.

10. The system of claim 8, wherein the means receiving medical data further comprises means for receiving femoral artery information.

11. The system of claim 6, further comprising:
a means for determining if a referral to a local doctor is necessary to construct the action plan.

12. The system of claim 6, further comprising:
means for determine cost of the insurance coverage if applicant has moderate cardiovascular risk;
means for constructing an action plan for reducing the applicant's cardiovascular risk if applicant is determined to have moderate cardiovascular risk; and
means for sending the action plan to the applicant.

13. A computer program product for providing underwriting insurance policies system, the computer program product comprising:
a tangible storage medium readable by a computer system and storing instructions for execution by the computer system for performing a method comprising:
receiving a request from an applicant for insurance;
receiving medical data of the applicant;
denying insurance coverage if applicant has high cardiovascular risk;
constructing an action plan for reducing the applicant's cardiovascular risk if applicant is denied coverage; and
sending the action plan to the applicant.

14. The computer program product of claim 13, wherein receiving medical data further comprises receiving coronary artery information.

15. The computer program product of claim 14, wherein receiving medical data further comprises receiving carotid artery information.

16. The computer program product of claim 14, wherein the receiving medical data further comprises receiving femoral artery information.

17. The computer program product of claim 13, further comprising:
determining if a referral to a local doctor is necessary to construct the action plan.

18. The computer program product of claim 13, further comprising:
determine cost of the insurance coverage if applicant has moderate cardiovascular risk;
constructing an action plan for reducing the applicant's cardiovascular risk if applicant is determined to have moderate cardiovascular risk; and
sending the action plan to the applicant.
